(19) United States
(12) Patent Application Publication
(10) Pub. No.: US 2013/0192722 A1
(43) Pub. Date: Aug. 1, 2013

(54) FLUX COMPOSITIONS FOR FORMING A SOLDER BUMP AND METHODS OF FABRICATING A SEMICONDUCTOR DEVICE USING THE SAME

(71) Applicants: Samsung Electronics Co., Ltd., Gyeonggi-do (KR); Dongwoo Fine-Chem Co., Ltd., Iksan-si (KR)

(72) Inventors: Dong-Min Kang, Seoul (KR); Sunghoon Kim, Iksan-si (KR); Ingoo Kang, Yongin-si (KR); Taesung Kim, Hwaseong-si (KR); Jungjae Myung, Iksan-si (KR); Sang Tae Kim, Iksan-si (KR); Shijin Sung, Iksan-si (KR); In-Kak Song, Dong-gu (KR); Seunghyun Ahn, Suwon-si (KR); Kyoochul Cho, Yongin-si (KR)

(73) Assignees: DONGWOO FINE-CHEM CO., LTD., Iksan-si (KR); SAMSUNG ELECTRONICS CO., LTD., Gyeonggi-do (KR)

(21) Appl. No.: 13/754,008

(22) Filed: Jan. 30, 2013

(30) Foreign Application Priority Data
Jan. 31, 2012 (KR) 10-2012-0009555

(51) Int. Cl. B23K 35/362

(52) U.S. Cl. CPC B23K 35/362
USPC 148/23

(57) ABSTRACT

The inventive concept provides flux compositions for forming a solder bump and methods of fabricating a semiconductor device using the same. The flux composition may include a resin, an activator, and a solvent. The resin may include gum rosin and rosin ester, and a mass ratio of the gum rosin versus the rosin ester may have a range of about 60:40 to about 90:10.

### CROSS-REFERENCE TO RELATED APPLICATIONS

This U.S. non-provisional patent application claims priority under 35 U.S.C. §119 to Korean Patent Application No. 10-2012-0009555, filed on Jan. 31, 2012, the entire contents of which are incorporated by reference herein.

### BACKGROUND

The inventive concept relates to flux compositions for forming a solder bump and methods of fabricating a semiconductor device using the compositions.

For mounting a semiconductor chip on a circuit board of an electronic device, a connection terminal such as a bump electrode may be formed on the semiconductor chip. The bump electrode may protrude on the semiconductor chip by several tens of microns and be disposed on a metal electrode of the semiconductor chip. As the semiconductor chip becomes highly integrated, development of the bump electrode having a relatively high accuracy has been demanded. In methods of forming a bump electrode, for example, a reflow process may be performed to melt a bump electrode having a circular cylinder-shape, thereby forming a bump electrode having a ball-shape. The reflow process may be performed using a flux composition.

Generally, as the size of the bump and a space between the bumps become reduced, the shape of the bump electrode influences an assembling yield and the importance of the shape of the bump electrode is embossed. When a conventional flux composition is used, bumps having undesirable shapes occur after the reflow process. Additionally, a residue of the flux remains on a surface of a substrate when a subsequent cleaning process is performed after the formation of the bump-shaped electrode.

### SUMMARY

Embodiments of the inventive concept may provide flux compositions which do not cause undesirable bump shapes. The residual flux compositions may also be removed by a cleaning process.

Embodiments of the inventive concept may also provide methods of fabricating a semiconductor device capable of reducing a process error rate.

In some embodiments, a flux composition for forming a solder bump may include a resin, an activator, and a solvent. Here, the resin may include gum rosin and rosin ester, and a mass ratio of the gum rosin versus the rosin ester may be in a range from about 60:40 to 90:10.

In some embodiments, the content of the resin may be in a range of about 10 wt % to 60 wt % with respect to a total weight of the flux composition, the content of the activator may be in a range of about 1 wt % to 5 wt % with respect to the total weight of the flux composition, and the content of the solvent may be in a range of about 35 wt % to 89 wt % with respect to the total weight of the flux composition.

In some embodiments, a method of fabricating a semiconductor device may include forming a bump on a substrate, providing a flux composition covering the bump, reflowing the bump, and removing a residual flux composition. The flux composition may include a resin, an activator, and a solvent. The resin may include gum rosin and rosin ester, and a mass ratio of the gum rosin versus the rosin ester may have a range of about 60:40 to 90:10.

### BRIEF DESCRIPTION OF THE DRAWINGS

The inventive concept will become more apparent in view of the attached drawings and accompanying detailed description.

FIGS. 1 to 5 are cross-sectional views illustrating a method of fabricating a semiconductor device according to some embodiments of the inventive concept;

FIG. 6 is a photograph of a solder bump fabricated according to a method exemplified in embodiment 2 of the inventive concept; and

FIG. 7 is a photograph of a solder bump fabricated according to a method exemplified in comparative example 2 of the inventive concept.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept. The same reference numerals or the same reference designators denote the same elements throughout the specification.

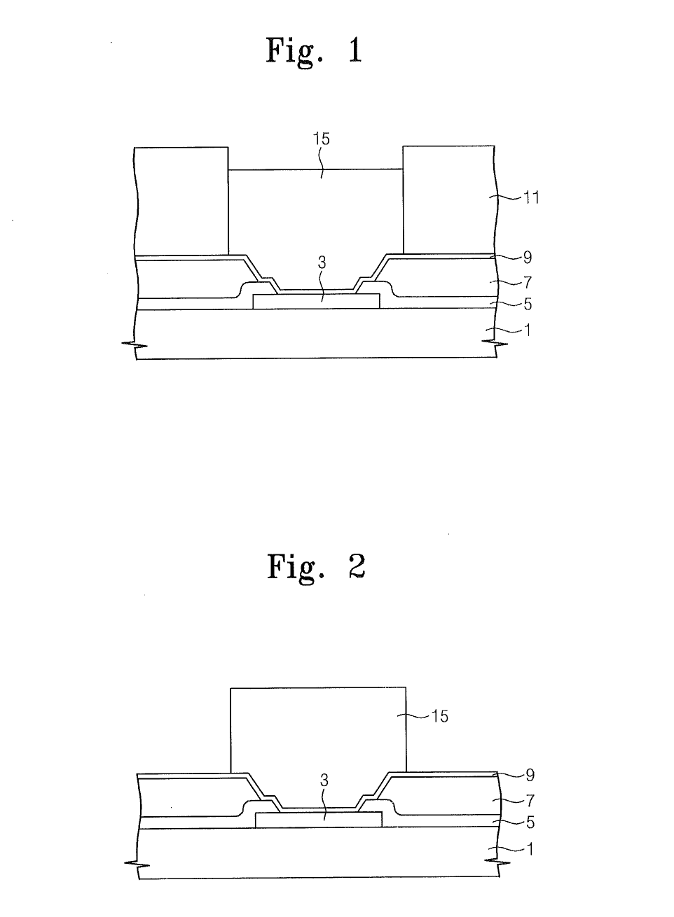

FIGS. 1 to 5 are cross-sectional views illustrating a method of fabricating a semiconductor device according to some embodiments of the inventive concept.

Referring to FIG. 1, a conductive pad 3 is formed on a substrate 1. The substrate 1 may include a semiconductor substrate, circuit patterns and interlayer insulating layers which are formed on the semiconductor substrate. A first passivation layer 5 and a second passivation layer 7 are formed to partially expose the conductive pad 3 and to cover the substrate 1. The first passivation layer 5 may be formed of, for example, a silicon nitride layer, and the second passivation layer 7 may be formed of, for example, a polyimide layer. A metal base layer 9 is conformally formed on an entire surface of the substrate 1 having the first and second passivation layers 5 and 7. The metal base layer 9 may be formed of, for example, a titanium layer and a copper containing layer. The titanium layer may function as a glue layer/a diffusion barrier layer. The copper containing layer may function as a seed layer. Photoresist patterns 11 may be formed on the metal base layer 9. The photoresist patterns 11 may be formed to expose the metal base layer 9 overlapped with the conductive pad 3. A bump 15 may be formed using a plating process on the metal base layer 9 which is not covered by the photoresist patterns 11. The bump 15 may fill a space between the photoresist patterns 11. The bump 15 may include at least one of lead, nickel, and tin.

Referring to FIG. 2, the photoresist patterns 11 may be removed using a photosensitive resin removal composition so as to expose the metal base layer 9. And then the exposed metal base layer 9 around the bump 15 may be removed to expose the second passivation layer 7.

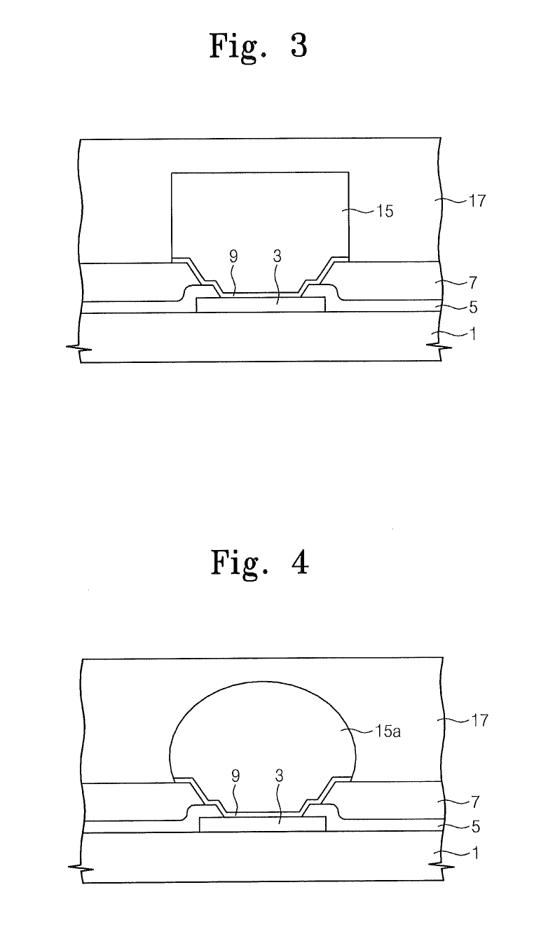

Referring to FIG. 3, a flux composition 17 for forming a solder bump is provided to cover the bump 15. Exemplary methods include spin coating or dip coating.

Referring to FIG. 4, the bump 15 is heated to be reflowed. Thus, a bump 15a having a ball-shape is formed.

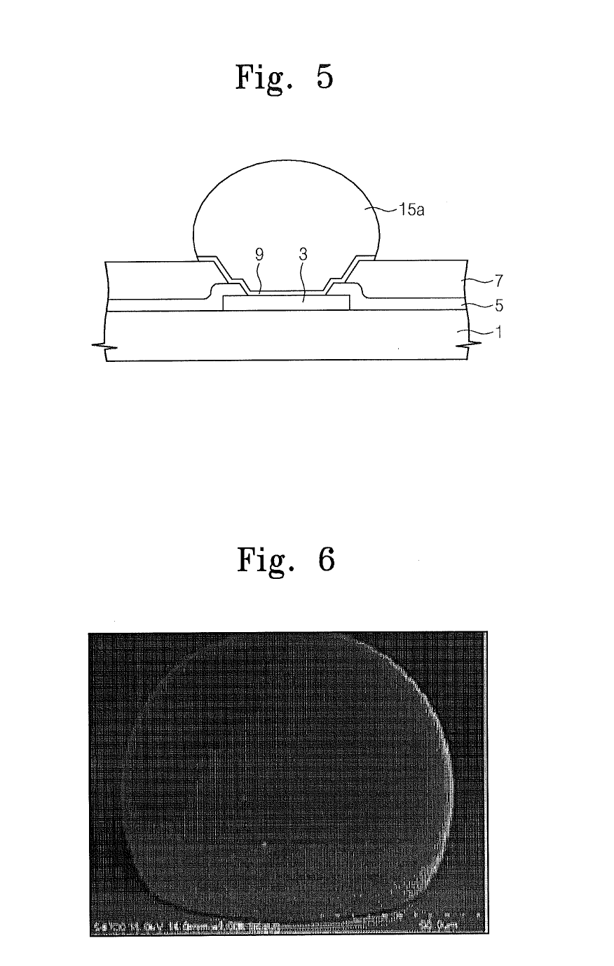

Referring to FIG. 5, a residual flux composition 17 is removed.

The flux composition for forming a solder bump according to an example of the inventive concept contains a resin, an activator, and a solvent. Here, the resin includes natural rosin and rosin derivatives. A mass ratio of the natural rosin versus the rosin derivatives has a range of about 60:40 to about 90:10.

The resin may correspond to a base of the flux composition for forming the solder bump. The resin may remove an oxide layer on a metal surface of the bump 15, decrease a surface tension for soldering, reduce a melting point, and/or prevent reoxidation of the metal surface.

The natural rosin may include at least one of gum rosin, de-oil rosin, and wood rosin. Particularly, the natural rosin may include the gum rosin which has a high acid value and a good activity to remove an oxide of the metal.

The rosin derivatives may include at least one of polymerized rosin, acrylic rosin, hydrogenation rosin, disproportionation rosin, formylation rosin, rosin ester, rosin modified maleic acid resin, rosin modified phenol resin, and rosin modified alkyd resin. Moreover, derivatives of rosins, rosin acids, and rosin salts include hydrogenation, epoxidation, dimerization, and the like. Particularly, the rosin derivatives may include rosin ester. Derivatives of rosin can also be prepared by reacting at least a portion of its carboxylic acid moieties, or of the carboxylate anions or acid chloride groups or the like, with moieties that form covalent bonds with the carboxylic carbonyl group, thereby rendering the rosin non-acidic and/or incapable of forming carboxylate salts. As notes above, examples of rosin derivatives include rosin esters, which may be prepared by esterification of the carboxylic acid moieties with alcohol moieties; and rosin amides, which may be prepared by reaction of the carboxylic acid moieties (or derivatives thereof such as the aforementioned esters and acid chloride) with amine moieties.

A content of the resin in the flux composition may have a range of about 0.5 wt % (weight %) to about 70 wt % with respect to a total weight of the flux composition. Particularly, the content of the resin in the flux composition may have a range of about 10 wt % to about 60 wt %. If the resin has the range described above, the oxide layer may be removed from the metal surface of the bump 15. Additionally, the surface tension for solder may be reduced, the melting point may be reduced, and/or the reoxidation of the metal surface may be prevented. Furthermore, the flux composition may sufficiently cover the bump 15, such that the bump 15 is well coated and/or an undesirable profile of a bump electrode does not occur.

The activator may include at least one of carboxylic acid, sultone acid, phosphoric acid, amino acid, and alkanolamine.

If the activator includes carboxylic acid, the activator may include at least one of oxalic acid, malonic acid, succinic acid, glutaric acid, adipic acid, pimeric acid, suberic acid, azelaic acid, sebacic acid, acetic acid, propionic acid, capric acid, heptanoic acid, lauric acid, myristic acid, palmitic acid, stearic acid, arachic acid, behenic acid, glycolic acid, lactic acid, malic acid, citric acid, and tartaric acid. Particularly, the activator may include at least one of succinic acid, glutaric acid, adipic acid, capric acid, and heptanoic acid. More particularly, the activator may include at least one of glutaric acid, adipic acid, and heptanoic acid. The activator including the carboxylic acid of glutaric acid, adipic acid, and/or heptanoic acid corresponds to an activator including dicarboxylic acid. The dicarboxylic acid provides a combination of solder bump performance, minimum ionic impurity residue, and/or high surface insulating resistance.

If the activator includes sultone acid, the activator may include butane sultone acid and/or sultone acid.

If the activator includes phosphoric acid, the activator may include at least one of tri-phenyl phosphate, phosphonate, pyro phosphoric acid, and meta phosphoric acid.

If the activator includes amino acid, the activator may include at least one of glycine, alanine, asparaginic acid, and glutamic acid.

If the activator includes alkanolamine, the activator may include at least one of diphenylamine, cyclohexylamine, triethanolamine, and monoethanolamine.

A content of the activator in the flux composition may have a range of about 1 wt % to about 10 wt % with respect to the total weight of the flux composition. Particularly, the content of the activator in the flux composition may have a range of about 1 wt % to about 5 wt %. If the ratio of the activator in the flux composition is less than the range described above, the activator does not provide sufficient flux activation to the flux composition. If the ratio of the activator in the flux composition is greater than the range described above, the activator may cause gloss-deterioration and/or excessive residues. Corrosiveness of the activator may then increase and may have a negative impact on the final assembling structure bumped by solder.

The resin may have a weak chemical activation, so that wettability and fluidity of the resin may be low during a process of forming the solder bump. However, the activator may be used for supplementing the above characteristics of the resin. Additionally, the activator may cause the flux composition to remove oxides from the metal surface of the bump 15. Furthermore, the activator has a slightly acidic component as compared with amine hydrohalide, for example, a halide containing activator such as amine hydrochloride or amine hydrobromide. Additionally, the activator does not have chlorine (Cl) or bromine (Br). Thus, the activator does not typically cause corrosive reaction of a lower structure and solder metal.

The activator may further include a nonionic covalent bond organic halogenide activator. The nonionic covalent bond organic halogenide activator may reduce a temperature at which an interaction of an activating component and a basic component begins, such that it facilitates the reflow process performance at a lower temperature. The nonionic covalent bond organic halogenide activator may be a bromide activator. The bromide activator may include at least one of trans-2,3-dibromo-2-butene-1,4-diol (DBD) and dibromostyrene.

The solvent may include at least one of glycol ether ester compound, glycol ether compound, ester compound, ketone compound, and cyclic ester compound.

The glycol ether ester compound may include at least one of ethylcellosolve acetate, methylcellosolve acetate, and propylene glycol monomethyl ether acetate.

The glycol ether compound may be propylene glycol monomethyl ether.

The ester compound may include at least one of ethyl lactate, butyl acetate, amyl acetate, and ethyl pyruvate.

The ketone compound may include at least one of acetone, methyl isobutylketone, 2-heptanone, cyclohexanone, and γ-butyrolactone.

Particularly, the solvent may include at least one of propylene glycol monomethyl ether acetate, and propylene glycol monomethyl ether.

A content of the solvent in the flux composition may have a range of about 20 wt % to about 98.5 wt % with respect to the total weight of the flux composition. Particularly, the content of the solvent in the flux composition may have a range of about 35 wt % to about 89 wt %.

The solvent according to embodiments of the inventive concept may solve problems of air pollution and an investment cost for additional pollution control equipment that may be caused by use of a volatile organic compound (VOC) such as isopropyl alcohol. Additionally, the solvent according to embodiments may have characteristics of non-flammability, non-explosivity, low toxicity, and/or low cost. Moreover, the solvent according to embodiments of the inventive concept may improve wettability of solder.

Additionally, the flux composition according to embodiments of the inventive concept may further include various additives such as a corrosion inhibitor, a dye, a blowing agent, a deformer agent, a sensitizer, another resin, a surfactant, and/or a stabilizing agent.

### Experimental Example

### 1) Fabrication of a Flux Composition for a Solder Bump

Components of various embodiments and comparative examples described in the following Table 1 were stirred according to corresponding composition ratios shown in Table 1 at 60° C. for about 2 hours. Thus, flux compositions for forming a solder bump were fabricated.

TABLE 1

| | Resin 1 | | Resin 2 | | Activator 1 | | Activator 2 | | Organic solvent | |
|---|---|---|---|---|---|---|---|---|---|---|
| | (wt %) | | (wt %) | | (wt %) | | (wt %) | | (wt %) | |
| Embodiment 1 | A-1 | 40 | A-2 | 10 | B-1 | 4 | — | — | PGME | 46 |
| Embodiment 2 | A-1 | 40 | A-2 | 10 | B-1 | 2 | — | — | PGME | 48 |
| Embodiment 3 | A-1 | 40 | A-2 | 10 | B-1 | 8 | — | — | PGME | 42 |
| Embodiment 4 | A-1 | 40 | A-2 | 10 | — | — | B-2 | 4 | PGME | 46 |
| Embodiment 5 | A-1 | 40 | A-2 | 10 | B-1 | 2 | B-2 | 2 | PGME | 46 |
| Embodiment 6 | A-1 | 40 | A-2 | 10 | B-1 | 1 | B-2 | 1 | PGME | 48 |
| Comparison | A-1 | 50 | — | — | B-1 | 4 | — | — | PGME | 46 |
| Example 1 | | | | | | | | | | |
| Comparison | — | — | A-2 | 50 | B-1 | 4 | — | — | PGME | 46 |
| Example 2 | | | | | | | | | | |
| Comparison | A-1 | 40 | A-3 | 10 | B-1 | 4 | — | — | PGME | 46 |
| Example 3 | | | | | | | | | | |
| Comparison | A-1 | 40 | A-2 | 55 | B-1 | 4 | — | — | PGME | 46 |
| Example 4 | | | A-3 | | | | | | | |
| Comparison | A-1 | 10 | A-2 | 40 | B-1 | 4 | — | — | PGME | 46 |
| Example 5 | | | | | | | | | | |
| Comparison | A-4 | 40 | A-2 | 10 | B-3 | 3 | B-4 | 2 | IPA | 45 |
| Example 6 | | | | | | | | | | |
| Comparison | A-4 | 50 | — | — | B-3 | 3 | B-5 | 2 | IPA | 45 |
| Example 7 | | | | | | | | | | |
| Comparison | A-4 | 40 | — | — | B-5 | 2 | — | — | IPA | 48 |
| Example 8 | | | | | | | | | | |
| Comparison | A-4 | 40 | — | — | B-5 | 2 | — | — | PGME | 48 |
| Example 9 | | | | | | | | | | |

Annotation)
A-1: Gum rosin (trade name: DX-100; a product of Laton Korea Co. LTD in Korea)
A-2: Rosin ester (trade name: KE-311; a product of Arakawa Chemical Industries. LTD in Japan)
A-3: Dehydrogenated rosin (trade name: DX-800H: a product of Laton Korea Co. LTD in Korea)
A-4: Polymerized rosin (a product of Pinechem. in China)
B-1: Glutaric acid (a product of Sigma-Aldrich Co. LLC.)
B-2: Heptanoic acid (a product of Sigma-Aldrich Co. LLC.)
B-3: Succinic acid (a product of Sigma-Aldrich Co. LLC.)
B-4: Ethylamine hydrochloride (a product of Sigma-Aldrich Co. LLC.)
B-5: Aniline hydrochloride (a product of Sigma-Aldrich Co. LLC.)
PGME: Propylene glycol monomethyl ether
IPA: Isopropyl alcohol

### 2) Reflow Profile Evaluation of Bumps

Each flux composition solution of the embodiments 1 to 6 and the comparative examples 1 to 9 was coated on a solder substrate where the bump ball process was performed. Thereafter, a thermal treatment was performed at about 250° C. to reflow the solder. Subsequently, the substrate having flux residues was soaked for 5 minutes in a cleaning solution to remove the flux residue. Thereafter, the soaked substrate was removed from the cleaning solution and then a spray cleaning process was performed on the substrate for about 3 minutes in a spray apparatus. At this time, a temperature of the cleaning solution was about 70° C. and a spray pressure was about 0.3 PMa. After the substrate was cleaned by water, a reflow profile of the bump ball on the substrate was observed by a scanning electron microscope (SEM). The results were shown in the following Table 2. In Table 2, a designator ‘⊚’ indicates an excellent profile and a designator ‘◯’ indicates a good profile. A designator ‘Δ’ indicates a normal profile and a designator ‘X’ indicates an undesirable profile.

### 3) Copper Corrosiveness Evaluation of Flux Compositions

A silicon substrate on which a single copper layer was formed was soaked in each of the flux compositions of the embodiments 1 to 6 and the comparative examples 1 to 9 for 10 minutes. The temperature of each of the flux compositions was about 70° C. A thickness of the copper layer was measured before the soaking and after soaking. The degree of corrosiveness of the copper layer was calculated from a thickness variation. The results were shown in the following Table 2.

In the following Table 2, a designator ‘⊚’ indicates non-corrosiveness. A designator ‘◯’ indicates that copper of less than about 10% is corroded. A designator ‘Δ’ indicates that copper of about 10% to about 50% is corroded. A designator ‘X’ indicates that copper of more than about 50% is corroded.

TABLE 2

| | Flux reflow profile | Copper corrosiveness |
|---|---|---|
| Embodiment 1 | ⊚ | ⊚ |
| Embodiment 2 | ⊚ | ⊚ |
| Embodiment 3 | ⊚ | ◯ |
| Embodiment 4 | ⊚ | ◯ |
| Embodiment 5 | ◯ | ◯ |
| Embodiment 6 | ◯ | ◯ |
| Comparison Example 1 | Δ | Δ |
| Comparison Example 2 | X | X |
| Comparison Example 3 | X | Δ |
| Comparison Example 4 | X | Δ |
| Comparison Example 5 | X | Δ |
| Comparison Example 6 | X | X |
| Comparison Example 7 | X | X |
| Comparison Example 8 | X | X |
| Comparison Example 9 | X | X |

Referring to Table 2, it is confirmed that the reflow profiles and the copper corrosiveness of the flux compositions of the embodiments 1 to 6 according to the inventive concept are good or excellent. On the contrary, it is confirmed that the reflow profiles and the copper corrosiveness of the flux compositions of the comparative examples 1 to 9 are not good.

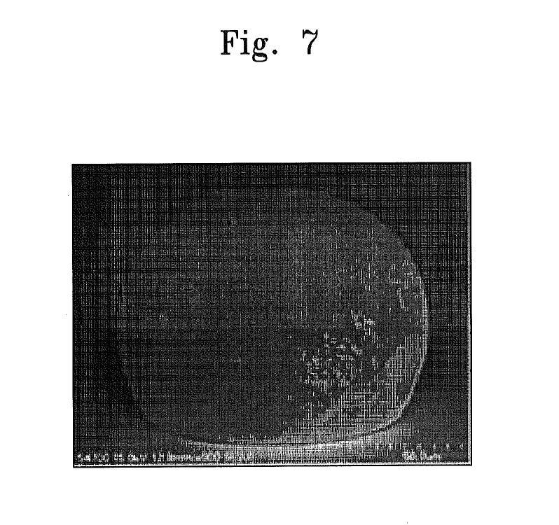

Meanwhile, FIG. 6 is a photograph of a solder bump fabricated according to embodiment 2 of the inventive concept, and FIG. 7 is a photograph of a solder bump fabricated according to comparative example 2 of the inventive concept.

Referring to FIGS. 6 and 7, the flux has a round ball shape in embodiment 2. However, the flux of comparative example 2 does not have a round ball shape but is distorted. Flaws are formed on a side surface of the distorted shape of the flux of comparative example 2.

Thus, when the solder bump is formed using the flux composition according to embodiments of the inventive concept, the shape of the bump may be good or excellent and a relatively poor shape of the bump may not occur. Additionally, residue of the flux composition according to embodiments of the inventive concept may not remain on the substrate after the cleaning process is performed. In other words, the flux composition according to embodiments of the inventive concept may be cleanly removed by the cleaning process. Thus, a process error rate may be reduced.

According to embodiments of the inventive concept, the flux composition for forming a solder bump provides a good or even excellent flux reflow profile and a good or excellent copper corrosiveness. Thus, when the solder bump is formed using the flux composition according to embodiments of the inventive concept, the shape of the bump may be good or even excellent and a relatively poor shape of the bump may not occur. Additionally, the flux may be cleanly removed by the cleaning process, such that the process error rate may be reduced.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept shall not be restricted or limited by the foregoing description.

1. A flux composition for forming a solder bump, comprising:
a resin;
an activator; and
a solvent,
wherein the resin includes gum rosin and rosin ester; and
wherein a mass ratio of the gum rosin versus the rosin ester has a range of about 60:40 to about 90:10.

2. The flux composition of claim 1, wherein the flux composition comprises:
a resin in a range of about 10 wt % to about 60 wt % of a total weight of the flux composition;
an activator in a range of about 1 wt % to about 5 wt % of the total weight of the flux composition; and
a solvent in a range of about 35 wt % to about 89 wt % of the total weight of the flux composition.

3. The flux composition of claim 1, wherein the activator includes a carboxylic acid.

4. The flux composition of claim 3, wherein the activator includes at least one of glutaric acid, adipic acid and heptanoic acid.

5. The flux composition of claim 3, wherein the activator further includes a covalent organic halogenide activator.

6. The flux composition of claim 5, wherein the covalent organic halogenide activator includes at least one of trans-2,3-dibromo-2-butene-1,4-diol and dibromostyrene.

7. The flux composition of claim 1, wherein the solvent includes at least one of a glycol ether ester compound, a glycol ether compound, an ester compound, a ketone compound, and a cyclic ester compound.

8. The flux composition of claim 7, wherein the solvent includes at least one of propylene glycol monomethyl ether acetate and propylene glycol monomethyl ether.

9-12. (canceled)

13. A flux composition, comprising:
a resin including a gum rosin and a rosin ester;
an activator including at least one of glutaric acid and heptanoic acid; and
a propylene glycol monomethyl ether solvent,
wherein a mass ratio of the gum rosin versus the rosin ester is in a range of about 60:40 to about 90:10.

14. The flux composition of claim 13, wherein the activator is glutaric acid.
